(19) United States
(12) Patent Application Publication
(10) Pub. No.: US 2010/0203909 A1
(43) Pub. Date: Aug. 12, 2010

(54) SYSTEM AND METHOD TO FACILITATE VOICE COMMUNICATION BETWEEN MEMBERS OF SOCIAL NETWORKING WEBSITES WHILE MAINTAINING MEMBER PRIVACY

(76) Inventor: Richard J. Oldach, Hopkinton, MA (US)

Correspondence Address: WINSTEAD PC, P.O. BOX 50784, DALLAS, TX, 75201, US

(21) Appl. No.: 12/703,844

(22) Filed: Feb. 11, 2010

Related U.S. Application Data
(60) Provisional application No. 61/151,752, filed on Feb. 11, 2009.

(51) Int. Cl. G06F 15/16; H04W 4/12

(52) U.S. Cl. 455/466; 709/203; 709/227; 709/204

(57) ABSTRACT

A method includes providing a social-networking service to a plurality of members over a first network. Each member of the plurality of members is identified to others of the plurality of members by a public member identifier (ID). The plurality of members includes a first member and a second member. The method also includes, for each member of the first member and the second member, registering personal contact information that uniquely identifies the member on a second network. The method also includes receiving a connection request from the first member to connect to the second member over the second network. The method also includes soliciting a connection response from the second member over the second network. The method also includes connecting the first member and the second member as directed by the connection response without revealing the personal contact information for the first member and the second member.

### CROSS-REFERENCE TO RELATED APPLICATIONS

This Application claims priority from, and incorporates by reference the entire disclosure of, U.S. Provisional Application No. 61/151,752 filed on Feb. 11, 2009.

### BACKGROUND

1. Technical Field

The present invention relates generally to social networking and, more particularly, but not by way of limitation, to systems and methods for facilitating voice and text communication between members of a social-networking website.

2. History of Related Art

Social-networking websites facilitate communication between members of a large and diverse member base. As a matter of design, social-networking websites generally allow registered members to communicate with one another within a protective environment defined and managed by the website without any need to provide personal contact information such as, for example, a mobile-phone number. This is because, typically, members of the social-networking websites desire to keep personal contact information private.

However, due at least in part to a focus on privacy, social-networking websites do not allow, for example, real-time voice or text-messaging communications between members. Although a member may be able to post personal information, such as, for example, a mobile-phone number, doing so sacrifices the member's privacy by opening the member up to unsolicited calls from a wide range of people. Additionally, once private contact information is made available to one or more members, there is no way to prevent further communication from the one or more members without obtaining, for example, a new mobile-phone number.

### SUMMARY OF THE INVENTION

In one embodiment of the present invention, a method includes, via a server computer that includes a processor and memory, providing a social-networking service to a plurality of members over a first network. Each member of the plurality of members is identified to others of the plurality of members by a public member identifier (ID). The plurality of members includes a first member and a second member. The method also includes, for each member of the first member and the second member, registering personal contact information that uniquely identifies the member on a second network. The second network is distinct from the first network. The registering includes privately storing the personal contact information in computer-readable storage. In addition, the method includes receiving via the social-networking service a connection request from the first member to connect to the second member over the second network. The method also includes, via a server computer having a processor and memory, soliciting a connection response from the second member over the second network. The soliciting includes providing the second member a menu of options for responding to the connection request. The method also includes, via an intermediary service resident between the first member and the second member on the second network, connecting the first member and the second member as directed by the connection response via the personal contact information for the first member and the second member without revealing the personal contact information for the first member and the second member.

The above summary of the invention is not intended to represent each embodiment or every aspect of the present invention.

### BRIEF DESCRIPTION OF THE DRAWINGS

A more complete understanding of the method and system of the present invention may be obtained by reference to the following Detailed Description when taken in conjunction with the accompanying Drawings wherein:

FIG. 1 is a diagram of a social-networking system that provides social-networking services to a plurality of members;

FIG. 2 illustrates a process for registering personal contact information of a member;

FIG. 3 illustrates a process for using a connection request to facilitate synchronous voice communication between members of a social-networking website;

FIG. 4 illustrates a process for using a connection response to facilitate synchronous voice communication between members of a social-networking website;

FIG. 5 illustrates a process for using a connection request to facilitate asynchronous text communication between members of a social-networking website;

FIG. 6 illustrates a process for using a connection response to facilitate asynchronous text communication between members of a social-networking website; and

FIG. 7 illustrates a process for allowing a requesting member to provide a pre-recorded or custom introduction to a receiving member.

### DETAILED DESCRIPTION OF ILLUSTRATIVE EMBODIMENTS OF THE INVENTION

In various embodiments, a social-networking system is operable to facilitate communication between registered members using a second network such as, for example, an existing network that supports traditional voice and/or text messaging (e.g., short message service (SMS)) communications without sacrificing the privacy of personal contact information. For example, in various embodiments, the social-networking system allows members to privately and securely store personal contact information that may be used to permit other members to connect to them over the second network.

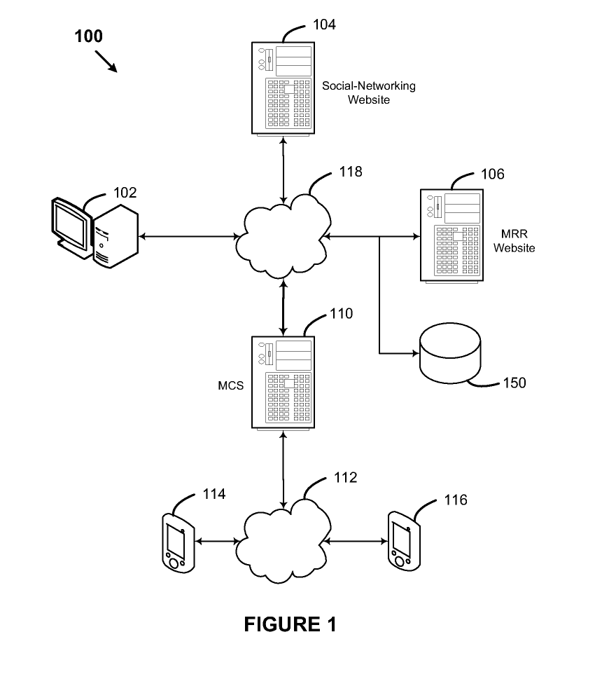

FIG. 1 is a diagram of a social-networking system 100 that provides social-networking services to a plurality of members. A member computer 102, a social-networking website 104, a member-registration-and-request (MRR) website 106, and a member-connection system (MCS) 110 are illustrated as being connected to a network 118. In some embodiments, the network 112 may be a computer network and even the Internet. In a typical embodiment, the MRR website 106 maintains and has data access to a personal contact information database 150. The personal contact information database 150 may be available for secure and authorized access over the network 118. The MCS 110 may be additionally connected to a second network 112 such as, for example, a traditional telephone network or a traditional mobile-phone network. In various embodiments, the MCS 110 may utilize Voice over Internet Protocol (VoIP) technology to access the second network. Various electronic devices such as, for example, member mobile phones 114 and 116 may be connected to and accessible via the second network 112.

As one of ordinary skill in the art will appreciate, in a typical embodiment, the social-networking website 104 abstracts communications between, for example, real-world people or entities into a membership framework defined and managed by the social-networking website 104. The social-networking website 104 may be accessed via, for example, a web browser operating on the member computer 102. In a typical embodiment, the social-networking website 104 registers, for example, a real-world person or entity as a member on the social-networking website 104 and associates at least one public member identifier (ID) with the member. In various embodiments, the public member ID may be, for example, a legal name, a user-selected screen name, an image, or other similar abstraction. In that way, other members of the social-networking website 104 may treat the public member ID as an abstraction for the member. While the social-networking website 104 typically maintains, at least internally, a key that uniquely identifies the member, one of ordinary skill in the art will recognize that the public member ID may not necessarily uniquely identify the member on the social-networking website 104. Moreover, in a typical embodiment, the public member ID may serve as a basis for communication and networking in a protective communicative environment provided by the social-networking website 104. Within the membership framework, the social-networking website 104 provides social-networking functionality that will be apparent to one of ordinary skill in the art and therefore will not be discussed in detail herein.

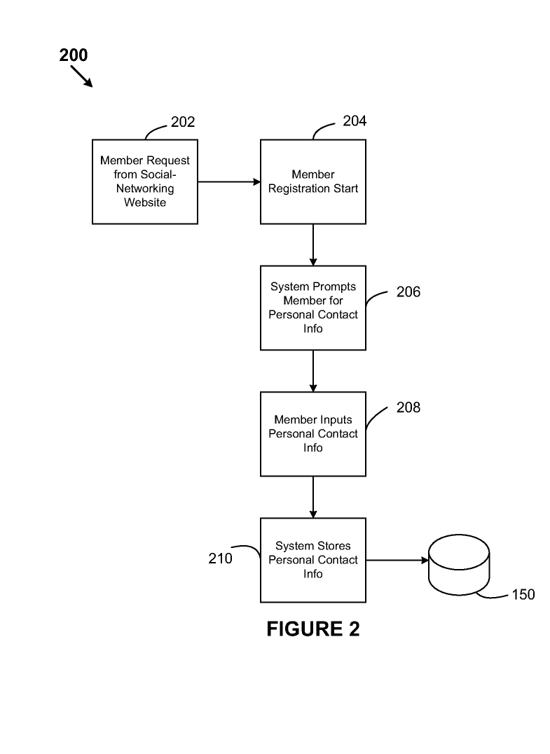

Although the social-networking website 104 and the MRR website 106 are illustrated separately for purposes of example and illustration, it is fully contemplated that, in some embodiments, the social-networking website 104 and the MRR web site 106 may be combined into one website, for example, to provide centralized hosting and management. In a typical embodiment, the MRR website 106 is operable to serve web pages that acquire private contact information from members of the social-networking website 104 and store the private contact information in the personal contact information database 150. The personal contact information database 150 is typically operable to link a public member ID for a member to any personal contact information provided by the member. For example, a member with a public member ID of “Baseball Fan” may provide a telephone number of “(555) 555-1235.” In the personal contact information database 150, the telephone number “(555) 555-1235” may be linked to a key that, at least internally, uniquely identifies the member and also to the public member ID of “Baseball Fan.” Exemplary registration functionality of the MRR website 106 will be discussed in more detail with respect to FIG. 2.

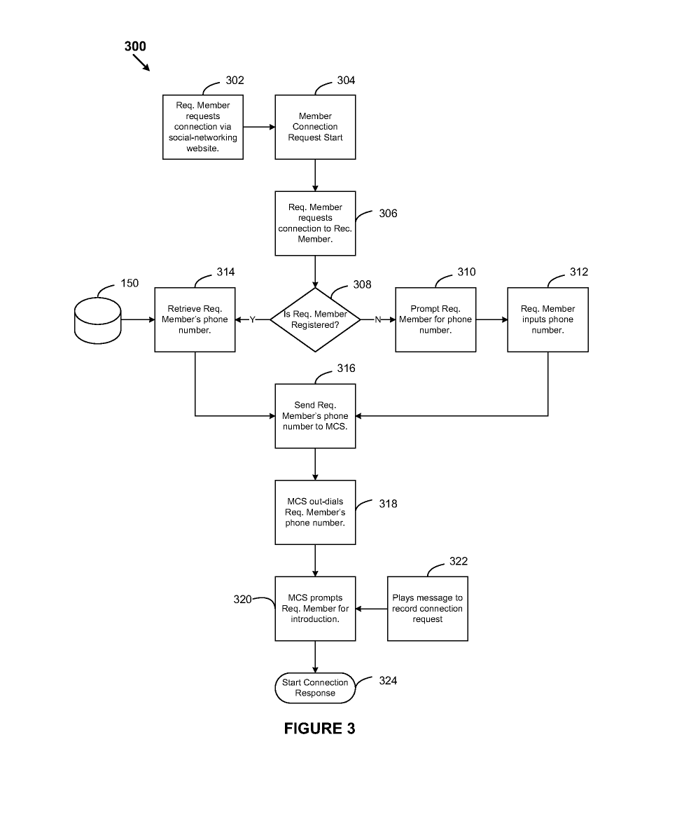

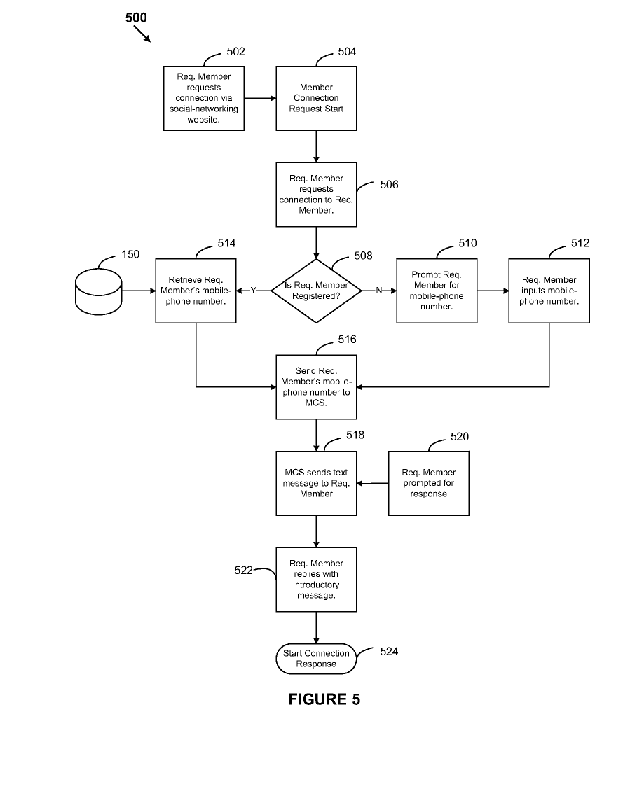

In a typical embodiment, the MRR website 106 is additionally operable to serve web pages that request a connection to another member of the social-networking website 104. In particular, a requesting member may initiate a connection request by selecting, for example, an appropriately-labeled icon on a webpage served by the social-networking website 104. Subsequently, the MRR website 106 may serve web pages to the requesting member in order to record details regarding the requesting member's request to connect to a receiving member. In various embodiments, the MRR website 106 in conjunction with the MCS 110 may support various forms of asynchronous and synchronous communication. For example, in various embodiments, the requesting member may choose to contact a member via synchronous voice communication, asynchronous voice communication, text messaging, and the like, depending on personal contact information stored for the receiving member in the personal contact information database 150. Exemplary connection-request functionality will be described in more detail with respect to FIGS. 3 and 5.

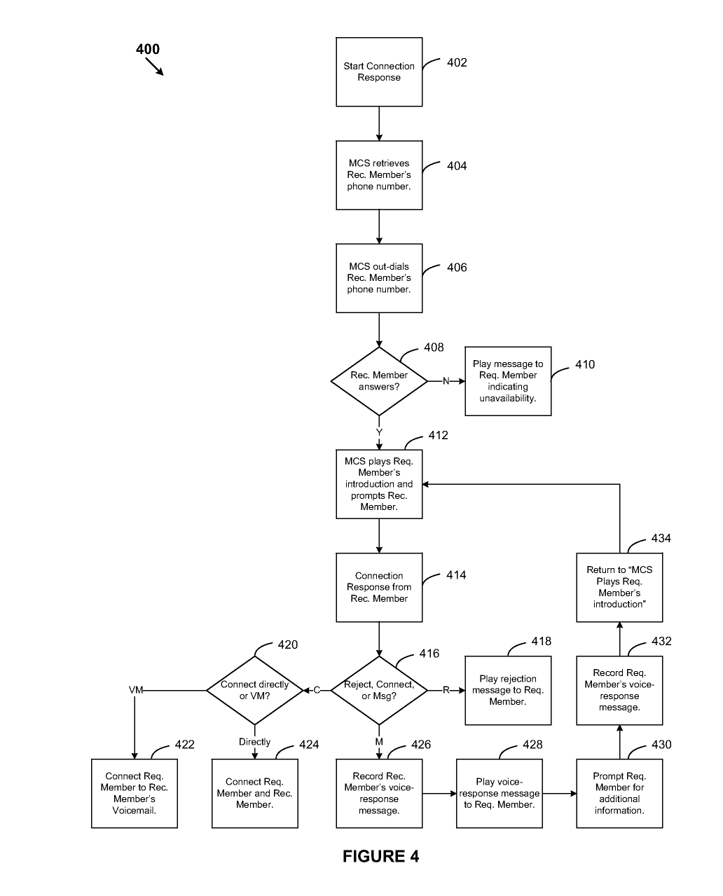

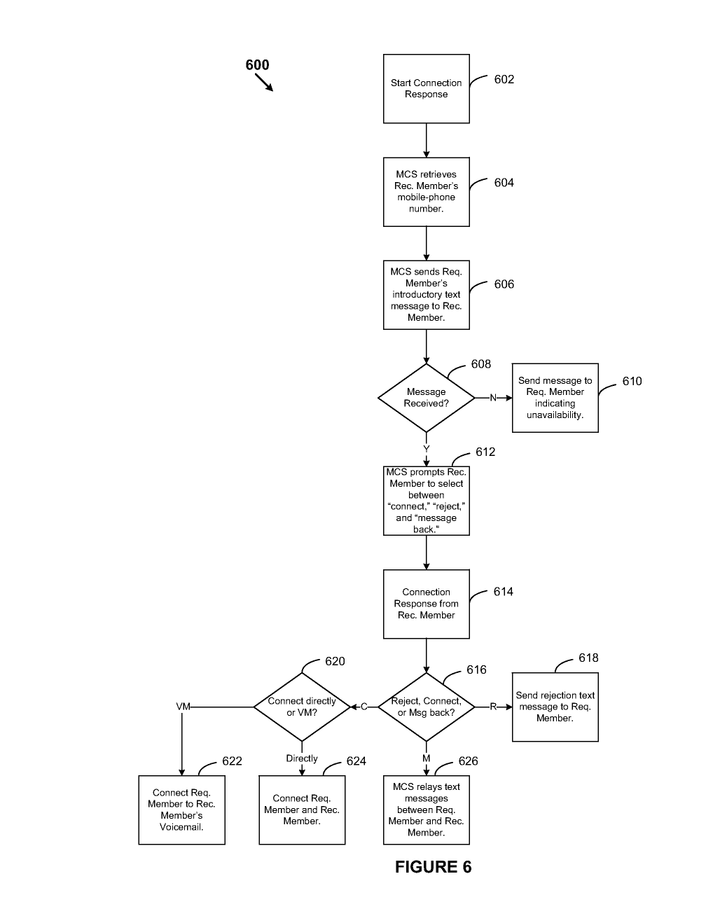

In a typical embodiment, the connection request is passed to the receiving member via the MCS 110. In a typical embodiment, the MCS 110 initiates connection-response functionality that allows the receiving member to determine if and how the connection request is to be handled. Exemplary connection-response functionality will be described in more detail with respect to FIGS. 4 and 6. In a typical embodiment, the MCS 110 transports the abstraction of the membership framework of the social-networking website 104 to communication over the second network 112. In other words, the MCS 110 is typically operable to serve as an intermediary service that bridges and/or relays communication between the requesting member and the receiving member over the second network 112. The communication over the second network 112 may, for example, utilize the member mobile phones 114 and 116. Exemplary functionality for the MCS 110 will be discussed in more detail with respect to the ensuing Figures.

FIG. 2 illustrates a process 200 for registering personal contact information of a member using, by way of example, the social-networking system 100 of FIG. 1. At step 202, the member may request that personal contact information be registered by, for example, selecting an appropriately-labeled link or icon on the social-networking website 104 of FIG. 1. At step 204, member registration may begin using the MRR website 106 of FIG. 1. At step 206, the MRR website 106 may serve web pages that prompt the member for the personal contact information. At step 208, the member may enter the personal contact information such as, for example, a mobile-phone number, into the served web pages and authorize transmission to the MRR website 106. At step 210, the MRR website 106 securely stores the personal contact information in the personal contact information database 150. Following step 210, the process 200 ends.

FIG. 3 illustrates a process 300 for using a connection request to facilitate synchronous voice communication between members of a social-networking website. For purposes of example and illustration, the process 300 is described with respect to the social-networking system 100 of FIG. 1. Additionally, for purposes of example and illustration, the process 300 describes the facilitation of synchronous voice communication over a traditional telephone network. At step 302, a requesting member may initiate the connection request by, for example, selecting an appropriately-labeled link or icon on a webpage served by the social-networking website 104. At step 304, the connection request begins on the MRR website 106. At step 306, via web pages served by the MRR website 106, the requesting member identifies a second member that the requesting member desires to contact via the connection request. For simplicity, the second member is referenced herein as a receiving member. For example, the requesting member may indicate a desire to contact “Baseball Fan” by telephone.

At step 308, the MRR website 106 may determine whether the requesting member has a telephone number registered in the personal contact information database 150. If so, the MRR website 106 retrieves the telephone number and the process 300 proceeds directly to step 316. If the requesting member does not have a telephone number registered in the personal contact information database 150, the requesting member may be prompted to provide a telephone number at step 310. At step 312, the requesting member may input the telephone number into a web page served by the MRR website 106 and authorize transmission back thereto. From step 312, the process 300 proceeds to the step 316.

At the step 316, the MRR website 106 transmits the telephone number for the requesting member to, for example, the MCS 110. At step 318, the MCS 110 out-dials the telephone number for the requesting member. At step 320, the MCS 110 may prompt the requesting member for an introduction and, subsequently, record the introduction. To prompt the requesting member, as indicated by block 322, the MCS 110 may play a message to the requesting member explaining that the MCS 110 is prompting the requesting member to record a message that will be used to introduce the requesting member to the receiving member. In various embodiments, the requesting member may be placed on hold pending a connection response from the receiving member. Following the step 322, the process 300 proceeds to step 324 for solicitation of the connection response from the receiving member and the process 300 ends.

FIG. 4 illustrates a process 400 for using a connection response to facilitate synchronous voice communication between members of a social-networking website. In a typical embodiment, the process 400 begins after the process 300 of FIG. 3 has been completed. For purposes of example and illustration, the process 400 is described with respect to the social-networking system 100 of FIG. 1. Additionally, for purposes of example and illustration, the process 400 describes the facilitation of synchronous voice communication over a traditional telephone network. At step 402, the process 400 begins on the MCS 110. At step 404, the MCS 110 may retrieve a telephone number for the receiving member from the personal contact information database 150. At step 406, the MCS 110 out-dials a call to the telephone number for the receiving member.

At step 408, the MCS 110 determines whether the receiving member answers the call. If not, at step 410, a message may be played to the requesting member indicating that the receiving member is not available and the process 400 ends. If the receiving member answers the call, at step 412 the MCS 110 plays an introduction for the receiving member such as, for example, the introduction recorded in step 320 of the process 300 described in FIG. 3. At step 414, the MCS 110 solicits and receives a connection response. In various embodiments, the MCS 110 may provide the receiving member a menu of options for creating a connection response. For example, in the process 400, the receiving member may be provided an option to connect the requesting member, an option to direct the requesting member to voicemail, an option to reject the connection request of the requesting member, and an option to record a voice-response message to be sent to the requesting member. In various embodiments, the receiving member may select from the menu of options using, for example, a keypad on a telephone.

At step 416, the MCS 110 receives the connection response from the receiving member and acts based thereon. In particular, at the step 416, the MCS 110 determines whether the receiving member has chosen to connect the requesting member in some manner (i.e., connect directly or indirectly via voicemail), send a voice-response message, or reject the connection request of the requesting caller. If the receiving member has chosen to reject the connection request of the requesting member, the MCS 110 plays a message to the requesting member so stating at step 418 and the process 400 ends. If the receiving member has chosen to connect the requesting member in some manner (i.e., connect directly or indirectly via voicemail), at step 420 the MCS 110 may determine whether the receiving member has chosen to directly connect the requesting member or to instead indirectly connect the requesting member by routing the requesting member to voicemail.

In a typical embodiment, the requesting member is still on hold following completion of, for example, the process 300. Therefore, if the receiving member has chosen to route the requesting member to voicemail, at step 422 the MCS 110 may connect the requesting member with the receiving member's voicemail. In various embodiments, the receiving member's voicemail may be a voicemail provided by the receiving member's telephone company or mobile-phone service provider. In these various embodiments, the MCS 110 may connect the requesting member to the receiving member's voicemail via an application programming interface (API) into the telephone company or mobile-phone service provider. In various other embodiments, the receiving member's voicemail may be a separate voicemail maintained by the MCS 110. Following the step 422, the process 400 ends. Alternatively, if the receiving member has chosen to directly connect the requesting member, the MCS 110 may bridge separate connections with the requesting member and the receiving member at step 424. In that way, the requesting member and the receiving member may take part in synchronous voice communication over a traditional telephone network while maintaining the privacy and the abstraction of the membership framework provided by the social-networking website 104. Following the step 424, the process 400 ends.

Returning to the step 416, if the receiving member has chosen to send a voice-response message as the connection response, at step 426 the MCS 110 may prompt the receiving member to record the voice-response message and, subsequently, record the voice-response message. In various embodiments, the voice-response message may be used by the receiving member to request additional information from the requesting member such as, for example, more specific identify information. At step 428, the voice-response message may be played to the requesting member. At step 430, the MCS 110 may prompt the requesting member to provide a voice-response message that includes, for example, more specific identity information as may have been requested by the receiving member. At step 432, the MCS 110 records the voice-response message from the requesting member. At step 434, the process 400 returns to step 412 to play the voice-response message from the requesting member to the receiving member. The process 400 continues until the receiving member rejects the connection request of the requesting member, connects the requesting member in some manner, or one of either the requesting member or the receiving member fails to respond to an introduction or voice-response message.

In various embodiments, members of the social-networking website 104 such as, for example, the receiving member, may establish default-handling instructions for the connection request. For example, the receiving member may choose to always reject certain members, always connect certain members as requested for all or some communication types, always route certain members to voicemail, or any combination thereof. In a typical embodiment, this functionality may be implemented through establishment of whitelists and blacklists in either the personal contact information database 150 or a separate member-preference database.

FIG. 5 illustrates a process 500 for using a connection request to facilitate asynchronous text communication between members of a social-networking website. For purposes of example and illustration, the process 500 is described with respect to the social-networking system 100 of FIG. 1. Additionally, for purposes of example and illustration, the process 500 describes the facilitation of asynchronous text communication over a traditional mobile-phone network via short message service (SMS). At step 502, a requesting member may initiate the connection request by, for example, selecting an appropriately-labeled link or icon on a webpage served by the social-networking website 104. At step 504, the connection request begins on the MRR website 106. At step 506, via web pages served by the MRR website 106, the requesting member identifies a second member that the requesting member desires to contact via the connection request. For simplicity, the second member will be referenced herein as a receiving member. For example, the requesting member may indicate a desire to contact “Baseball Fan” by text message.

At step 508, the MRR website 106 may determine whether the requesting member has a mobile-phone number registered in the personal contact information database 150. If so, the MRR website 106 retrieves the mobile-phone number and the process 500 proceeds directly to step 516. If the requesting member does not have a mobile-phone number registered in the personal contact information database 150, the requesting member may be prompted to provide a mobile-phone number at step 510. At step 512, the requesting member may input the mobile-phone number into a web page served by the MRR website 106 and authorize transmission back thereto. From step 512, the process 500 proceeds to the step 516.

At the step 516, the MRR website 106 transmits the mobile-phone number for the requesting member to the MCS 110. At step 518, the MCS 110 transmits, for example, an initial text message to the mobile-phone number for the requesting member. As indicated by block 520, the MCS 110 may explain in the initial text message that the MCS 110 is prompting the requesting member for a message that will be used to introduce the requesting member to the receiving member. At step 522, the requesting member responds with an introductory text message. Following the step 522, the process 500 proceeds to step 524 for solicitation of a connection response from the receiving member and the process 500 ends.

FIG. 6 illustrates a process 600 for using a connection response to facilitate asynchronous text communication between members of a social-networking website. In a typical embodiment, the process 600 begins after the process 500 of FIG. 5 has been completed. For purposes of example and illustration, the process 600 is described with respect to the social-networking system 100 of FIG. 1. Additionally, for purposes of example and illustration, the process 600 describes the facilitation of asynchronous text communication over a traditional mobile-phone network via SMS. At step 602, the process 600 begins on the MCS 110. At step 604, the MCS 110 may retrieve a mobile-phone number for the receiving member from the personal contact information database 150. At step 606, the MCS 110 sends an introductory text message such as, for example, the introductory message created in the step 522 of FIG. 5, to the mobile-phone number for the receiving member.

At step 608, the MCS 110 determines whether the transmission of the introductory text message to the receiving member is successful. If not, at step 610, a text message may be sent to the requesting member indicating that the receiving member is not available and the process 600 ends. If the transmission of the introductory text message is determined to be successful, at step 612 the MCS 110 may solicit and receive a connection response from the receiving member. In various embodiments, the MCS 110 may provide the receiving member a menu of options for creating the connection response. For example, in the process 600, the receiving member may be provided an option to connect the requesting member for synchronous voice communication, an option to direct the requesting member to voicemail, an option to reject the connection request of the requesting member, and an option to message back, that is, send a text message to the requesting member. At step 614, the receiving member may transmit the connection response to the MCS 110 via, for example, text message.

At step 616, the MCS 110 receives the connection response from the receiving member and may act based thereon. In particular, at the step 616, the MCS 110 may determine whether the receiving member has chosen to connect the requesting member for synchronous voice communication, direct the requesting member to voicemail, reject the connection request of the requesting member, or message back. If the receiving member has chosen to reject the connection request of the requesting member, the MCS 110 sends a text message to the requesting member so stating at step 618 and the process 600 ends.

If the receiving member has chosen to connect the requesting member for some manner of voice communication (i.e., connect directly or indirectly via voicemail), at step 620 the MCS 110 may determine whether the receiving member has chosen to directly connect the requesting member or to instead indirectly connect the requesting member by routing the requesting member to a voicemail for the receiving member. If the receiving member has chosen to route the requesting member to voicemail, at step 622 the MCS 110 may out-dial the mobile-phone number for the requesting member and connect the requesting member to the voicemail for the receiving member in a manner similar to that described with respect to the step 422 of FIG. 4. If the receiving member has chosen to directly connect the requesting member, the MCS 110 acts accordingly at step 624. In various embodiments, at the step 624 the receiving member becomes a requesting member for a process similar to the process 300 of FIG. 3 for using a connection request and the process 400 of FIG. 4 for using a connection response. In various other embodiments, the MCS may simply obtain telephone numbers for the requesting member and the receiving member, out-dial the telephone numbers, and bridge the requesting member and the receiving member for synchronous voice communication.

Returning to the step 616, if the receiving member has chosen to message back, at step 626 the MCS 110 acts as requested and serves as an intermediary for text communication between the requesting member and the receiving member over the traditional mobile-phone network via, for example, SMS. In that way, the requesting member and the receiving member may be connected for asynchronous text communication over a traditional mobile-phone network while maintaining the privacy and the abstraction of the membership framework provided by the social-networking website 104. Following the step 626, the process 600 ends.

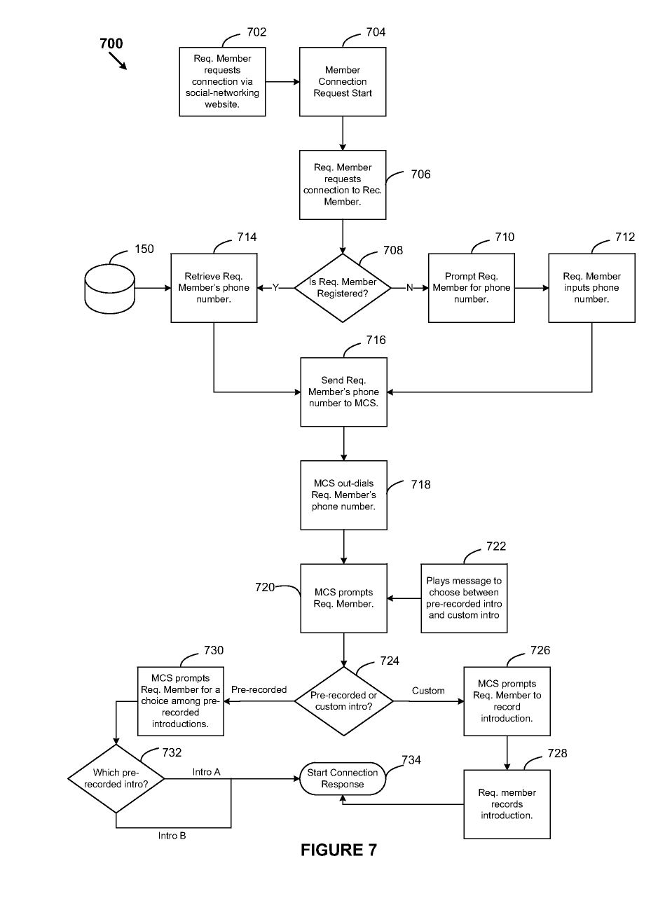

FIG. 7 illustrates a process 700 for allowing a requesting member to provide a pre-recorded or custom introduction to a receiving member. As discussed above with respect to the process 300 of FIG. 3, in various embodiments a requesting member may record a message that may be used to introduce the requesting member to the receiving member for purposes of a connection request for synchronous voice communication over, for example, a traditional telephone network. In the process 700, the requesting member instead may be permitted to choose between pre-recorded and custom introductions. One of ordinary skill in the art will note that steps 702-718 are substantially identical to steps 302-318 of the process 300. Therefore, the present discussion of the process 700 commences with step 720.

At the step 720, the MCS 110 may prompt the requesting member to choose between selecting a pre-recorded introduction and recording a custom introduction. To prompt the requesting member, as indicated by block 722, the MCS 110 may play a message to the requesting member. At step 724, the MCS 110 receives a selection from the requesting member. If the requesting member has chosen to record a custom introduction, at step 726 the MCS 110 may prompt the requesting member to speak an introduction. At step 728, the MCS 110 may record the introduction spoken by the requesting member. From step 728, the process 700 proceeds to step 734.

If the requesting member has chosen to select a pre-recorded introduction, at step 730 the MCS 110 may prompt the requesting member with a menu of pre-recorded introductions. In various embodiments, the MCS 110 may play a sequence of pre-recorded introductions for review by the requesting member. At step 732, the requesting member may choose a pre-recorded introduction using, for example, a key pad on telephone or mobile phone. From step 732, the process 700 proceeds to the step 734. At the step 734, the MCS 110 proceeds with solicitation of a connection response as described, for example, with respect to FIG. 4 and the process 700 ends.

In various embodiments, the process 700 of FIG. 7 may be utilized to facilitate asynchronous voice communication between the requesting member and the receiving member. In the various embodiments, the requesting member may record a voice message to the receiving member rather than merely an introductory message. In a similar manner to that described in the process 400 of FIG. 4, the MCS 110 may out-dial a telephone number for the receiving member and play the voice message to the receiving member. Subsequently, the receiving member may be provided an opportunity to follow a process similar to the process 700 to record a responsive voice message. Therefore, the MCS 110 may serve as an intermediary for asynchronous voice communication between the requesting member and the receiving member over the traditional telephone network. In that way, the requesting member and the receiving member may take part in asynchronous voice communication over a traditional telephone network while maintaining the privacy and the abstraction of the membership framework provided by the social-networking website 104.

Although FIGS. 3-7 disclose various exemplary steps of exemplary processes, it is contemplated that many embodiments may utilize different combinations of steps from the exemplary processes. For example, it is contemplated that, in some embodiments, a connection request and a connection response for synchronous voice communication may be facilitated via, for example, SMS text messaging in a manner similar to that described with respect to FIG. 5. In these embodiments, if an appropriate connection response is received as discussed with respect to FIGS. 4 and 6, an MCS such as, for example, the MCS 110 may out-dial telephone numbers for both the requesting member and the receiving member for purposes of facilitating synchronous voice communication.

Moreover, one of ordinary skill in the art will note that various principles disclosed in the foregoing may be applied in diverse ways that are not explicitly discussed above. For example, in some embodiments, it may be advantageous to broadcast a text message or a voice message to a group of members from a social-networking website such as, for example, the social-networking website 104. In a similar manner, it may be advantageous to broadcast a connection request to a group of members, for example, in order to organize a telephone conference. Numerous other features based on the foregoing will be apparent to one of ordinary skill in the art.

Although various embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth herein.

What is claimed is:

1. A method comprising:
via a server computer comprising a processor and memory, providing a social-networking service to a plurality of members over a first network, each member of the plurality of members being identified to others of the plurality of members by a public member identifier (ID), the plurality of members comprising a first member and a second member;
for each member of the first member and the second member, registering personal contact information that uniquely identifies the member on a second network;
wherein the second network is distinct from the first network;
wherein the registering comprises privately storing the personal contact information in computer-readable storage;
receiving via the social-networking service a connection request from the first member to connect to the second member over the second network;
via a server computer having a processor and memory, soliciting a connection response from the second member over the second network, the soliciting comprising providing the second member a menu of options for responding to the connection request; and
via an intermediary service resident between the first member and the second member on the second network, connecting the first member and the second member as directed by the connection response via the personal contact information for the first member and the second member without revealing the personal contact information for the first member and the second member.

2. The method of claim 1, wherein the connecting comprises:
identifying the first member to the second member only via the public member ID for the first member; and
identifying the second member to the first member only via the public member ID for the second member.

3. The method of claim 1, comprising providing an option to the first member of specifying a type of communication in the connection request.

4. The method of claim 3, wherein the providing comprises providing a menu of options comprising at least one form of asynchronous communication over the second network and at least one form of synchronous communication over the second network.

5. The method of claim 4, comprising:
wherein the at least one form of synchronous communication comprises synchronous voice communication and the second network comprises a telephone network;
wherein the personal contact information of the first member and the personal contact information of the second member each comprise a telephone number;
out-dialing the telephone number of the first member responsive to the receiving; and
wherein the soliciting comprises out-dialing the telephone number of the second member and providing the menu of options to the second member via the telephone network.

6. The method of claim 5, wherein the connecting comprises routing the first member to a voicemail of the second member responsive to the connection response.

7. The method of claim 5, wherein the connecting comprises playing a message to the first member indicating that the connection request has been rejected responsive to the connection response.

8. The method of claim 5, wherein the soliciting comprises:
providing an option to the second member of requesting additional information from the first member regarding the connection request;
recording a voice-response message from the second member responsive to the second member selecting the option of requesting additional information;
playing the voice-response message to the first member;
receiving a voice-response message from the first member responsive to the voice-response message from the second member;
playing the voice-response message from the first member to the second member; and
soliciting a new connection response from the second member over the second network.

9. The method of claim 5, wherein:
the connecting comprises initiating synchronous voice communication between the first member and the second member over the telephone network; and
the initiating comprises bridging the first member and the second member via the intermediary service.

10. The method of claim 5, comprising:
recording an introductory message from the first member, the introductory message introducing the first member to the second member; and
wherein the soliciting comprises playing the introductory voice message to the second member.

11. The method of claim 5, comprising:
allowing the first member to select one of a plurality of pre-recorded messages as an introductory message; and
wherein the soliciting comprises playing the introductory message to the second member, the introductory message being utilized to introduce the first member to the second member.

12. The method of claim 4, comprising:
wherein the at least one form of synchronous communication comprises synchronous voice communication;
wherein the second network comprises a telephone network;
wherein the personal contact information of the first member and the personal contact information of the second member each comprise a mobile-phone number;
prompting the first member via a text message over a mobile-phone network to send an introductory text message to the intermediary service;
receiving the introductory text message; and
wherein the soliciting comprises sending the introductory text message to the second member.

13. The method of claim 12, wherein the connecting comprises:
out-dialing the mobile-phone number of the first member;
out-dialing the mobile-phone number of the second member; and
initiating synchronous voice communication between the first member and the second member over the mobile-phone network, the initiating comprising bridging the first member and the second member via the intermediary service.

14. The method of claim 4, comprising:
wherein the at least one form of asynchronous communication comprises text-messaging communication;
wherein the second network comprises a mobile-phone network;
wherein the personal contact information of the first member and the personal contact information of the second member each comprise a mobile-phone number;
sending a text message to the mobile-phone number of the first member responsive to the receiving; and
wherein the soliciting comprises sending a text message to the mobile-phone number of the second member and providing the menu of options to the second member via the text message.

15. The method of claim 14, wherein the connecting comprises, responsive to the connection response, sending a text message to the mobile-phone number of the first member indicating that the connection request has been rejected.

16. The method of claim 14, wherein:
the connecting comprises facilitating asynchronous text-messaging communication between the first member and the second member over the mobile-phone network; and
the facilitating comprises relaying text messages between the first member and the second member via the intermediary service.

17. The method of claim 14, comprising:
wherein the sending of a text message to the mobile-phone number of the first member comprises prompting the first member to send an introductory text message to the intermediary service;
receiving the introductory text message; and
wherein the soliciting comprises sending the introductory text message to the second member.

18. The method of claim 1, comprising:
allowing the second member to establish default-handling instructions for connection requests from at least the first member;
storing the default-handling instructions in computer-readable storage; and
retrieving the default-handling instructions as the connection response responsive to the connection request.

19. The method of claim 4, wherein the at least one form of asynchronous communication comprises asynchronous voice communication.

20. A computer-program product comprising a computer-usable medium having computer-readable program code embodied therein, the computer-readable program code adapted to be executed to implement a communication method comprising:
providing a social-networking service to a plurality of members over a first network, each member of the plurality of members being identified to others of the plurality of members by a public member identifier (ID), the plurality of members comprising a first member and a second member;
for each member of the first member and the second member, registering personal contact information that uniquely identifies the member on a second network;
wherein the second network is distinct from the first network;
wherein the registering comprises privately storing the personal contact information in computer-readable storage;
receiving via the social-networking service a connection request from the first member to connect to the second member over the second network;
soliciting a connection response from the second member over the second network, the soliciting comprising providing the second member a menu of options for responding to the connection request; and
via an intermediary service resident between the first member and the second member on the second network, connecting the first member and the second member as directed by the connection response via the personal contact information for the first member and the second member without revealing the personal contact information for the first member and the second member.
